(19) United States
(12) Patent Application Publication
(10) Pub. No.: US 2024/0037082 A1
(43) Pub. Date: Feb. 1, 2024

(54) IMPORTING DATA TO A TABULAR DATABASE

(71) Applicant: VAST DATA LTD., Tel Aviv (IL)

(72) Inventors: Asaf Levy, Tel Aviv (IL); Eyal Gordon, Tel Aviv (IL)

(73) Assignee: VAST DATA LTD., Tel Aviv (IL)

(21) Appl. No.: 17/877,947

(22) Filed: Jul. 31, 2022

(51) Int. Cl. G06F 16/22; G06F 16/23

(52) U.S. Cl. CPC G06F 16/2282; G06F 16/2386

(57) ABSTRACT

A method for importing data to a tabular database (TD), the method includes: determining that data was written, using a file system command, to a file system location; wherein the file system location is associated with at least a part of the TD; and automatically importing the data to the at least part of the TD.

### TECHNICAL FIELD

The present disclosure generally relates to the field of data storage, and more particularly to importing data to a tabular database (TD).

### BACKGROUND

Loading bulks of data into database tables is a routine task. A “Bulk insert” (or “bulk collect”) is an example of a command provided by a database management system to load many rows of data into a tabular database. Bulk commands issued by a client specify a target table at the database system and a file name of a file that includes the data to be imported into the target table.

The bulk upload is a cumbersome process that requires specifying a file each time a new bulk of data needs to be uploaded, and many users eventually forget to perform the bulk upload operations—especially when there are constant streams of bulks and/or when the tabular database should be frequently updated.

### SUMMARY

There may be provide a storage system, a method and a non-transitory computer readable medium for importing data to a tabular database.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example of a storage system;

FIG. 2 is an example of a method; and

FIG. 3 is an example of a storage system and its environment.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

The specification and/or drawings may refer to a compute core. The compute core can be a processing circuitry, a part of processing circuitry, a virtual machine core, and the like. The processing circuitry may be implemented as a central processing unit (CPU), a graphic processing circuitry (GPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the application may be provided.

There are provided storage systems, methods, and non-transitory computer readable media for importing data to a tabular database (TD) stored at the storage system. For simplicity of explanation, the following text may refer to a storage system. The TD may include one or more tables. A part of the TD may be a part of a table, a table, more than a single table, and the like.

The storage system described herein provides creation of a mapping between a file system location (also referred to as a pathname or path) and at least a part of the TD that enables a user accessing the storage system to repeatedly upload large amounts of data destined to a database table associated with the file system location.

The definition of the mapping enables the user to send various data files addressed to a path of a location within the storage system, wherein the data files that land at the location identified by the path are to be migrated into a specific database table stored in the storage system, according to the rules defined by the mapping, and without requiring any further queries or instructions from the user, with respect to the landed data files.

Once the mapping is defined—any file received by the storage system that is addressed to a path defined by the mapping will be automatically migrated to the corresponding table, by the storage system.

The storage system supports both filesystem interface for filesystem commands received via file protocols, for accessing files stored in the system, as well as database interface for receiving queries addressed to database tables stored in the storage system.

The mapping correlates a filesystem path (a specific directory or sub-tree) to a specific database table. Once the mapping is defined, the user can use file commands carried over file protocols to send files from the user computer into the storage system, without needing to pre-define the names of the files that need to be imported into the TD, and without issuing a query for inserting data into a database, each time a file is ready to be migrated into the database.

Since the storage system supports file interfaces, the user can send filesystem commands, to the storage system, for creating a directory or a sub-tree of directories that will be used to store files, received from the user, with content destined to database tables. The commands for creating a directory may be received via a standard filesystem protocol, such as NFS, SMB, etc.

The storage system enables the user to create a new mapping that can be used for repeatedly uploading data destined to database tables, by defining an associating between a DB table's name and a filesystem path to a directory previously created by the user. The mapping creation may be done via a management interface of the system. The mapping may further define an association between filesystem sub-paths and columns of the specified table.

The mapping may be associated with one or more rules, for example: (i) which file types found under the filesystem path will be considered as files including content to be migrated to the specified database table; (ii) whether the imported files are to be deleted after their data is migrated to the DB tables. If the files are not to be deleted after their data is migrated to the DB tables, then it is up to the user to delete these files, again by using standard file commands. In this case, the system should distinguish between new files found under the path and files that were already imported to DB tables and are still stored under the path.

Once one or more mappings are defined, the system repeatedly scans the corresponding directories for new files to be migrated to DB tables. The destination DB table is identified according to the directory where a new file is found and according to the mapping definition that correlates a directory and a DB table. The system then copies the content of the new imported file into the corresponding table.

The storage system creates a tracking list for logging files that were already imported into DB tables. The tracking list includes various identifiers needed for identifying imported files, e.g., file name (and/or other file identifier—inode, handle), size, time of import, and optionally, hash value of at least part of the content of the file. The hash value may be needed, for example, in cases where the user sent the same content twice or when there is a problem with the clock that defined the time of import. The content of the tracking list can be exposed to the user upon request.

The system scans the one or more defined paths, periodically according to an import schedule, upon an explicit user command, or upon both.

New files to be migrated to tables are those that are not listed in the tracking list. Alternatively, the system may identify new files according to their creation time and the time of the previous import cycle. The system may select only files of certain format types (e.g., tabular formats) or file format that were explicitly defined by the mapping rules. The file format may be identified by the files' extension, e.g., “.csv”, “.parquet”, etc.). Therefore, the user may use a temporary file name (e.g., having the extension “.tmp”) during the copying of the file from the user computer to the storage system, and change the name of the file to a name indicating a valid file, after the copying is completed.

The system may take a snapshot of a mapping's directory, before starting an import cycle, and then performs the import based of the frozen content of the snapshotted directory, so that changes that occur during the import (by a user that has a free access to this directory), would not interfere with the import process.

Users may handle Parquet datasets or other tabular/columnar file formats that include partitions. Using partitioned format, tabular formatted content may be separated to sub-directories, where each sub-directory corresponds to a column of the tabular format. Such columns are divided into partitions based on column values, where the content of the rows (other than the content of the partitioned column) is saved as separate files in separate sub-directories. For example, a sub-directory named “country” may include a file (or a lower sub-directory) per country, or a sub-directory named “date” may include a file per day.

For allowing a user that uses a partitioned format to send the files without changing the format, the definition of the mapping may include allowing the user to define association between a column of the DB table and a path of a sub-directory (sub-path) under the main directory that is associated with the DB table in the mapping definition. Upon an import cycle, when files are detected under a sub-directory (directly or indirectly further under descendants of the sub-directory) that is associated with a column, the content of these files is copied to the table, and the values under the column associated with the sub-directory are filled with fixed values indicated by the file's pathname. For example, suppose the sub-path (sub-directory) ‘/path1/country’ is associated with a column named “country” of a DB table named “table1” (associated with the path “/path1”)—if under the directory “country” there are further descendant directories (e.g., named “Austria”, “US”, or other country names), and there are new files under these descendant directories, then the values in the corresponding column will be set to the names of these directories.

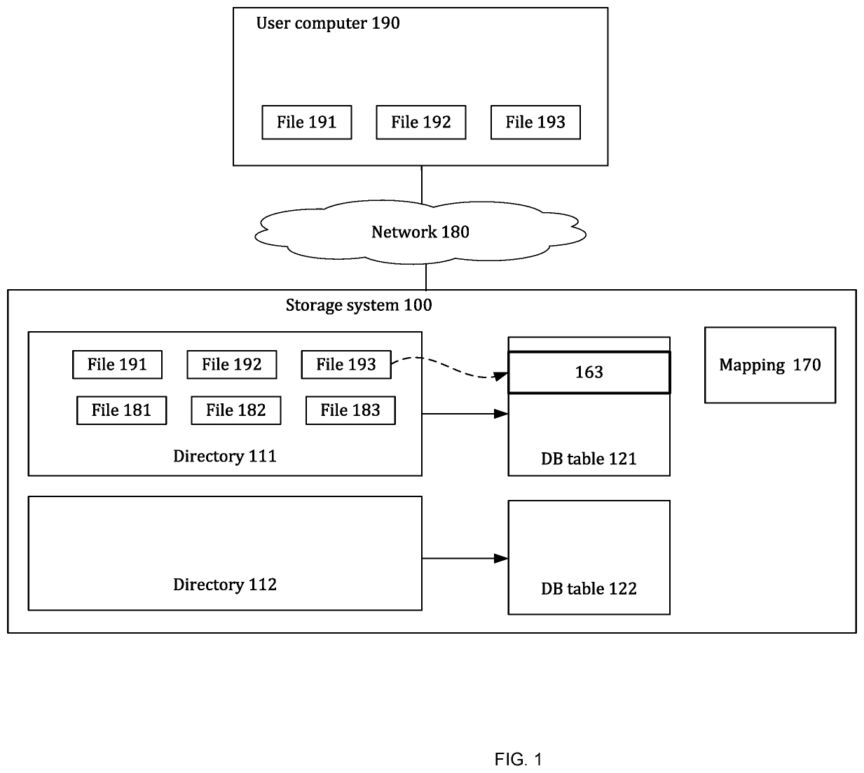

FIG. 1 illustrates a storage system 100 that is coupled to a user computer 190 via a communication network 180. User computer 190 may send data that may be organized in files, for example files 191-193 from the user storage space to the storage system to be stored under a path of a directory 111. The data may be organized in other manners—not as a file.

The path of directory 111 is defined as part of a mapping for DB table 121, meaning that any file that is found under directory 111 will be migrated to table 121. Another directory 112 may be defined by another mapping for DB table 122.

The files 191-193 received from the user computer are stored under directory 111 according to the received file write request that indicates the target directory 111 of the write, which may store other files 181-183, that may be waiting to be migrated to table 121, or may be already migrated, but the configuration of the corresponding mapping defines that migrated files are not to be deleted after migration.

The content of each file is written to the table as a group of rows. For example, file 193 is written to table 121 as a group of rows 163. FIG. 1 also illustrates an example of mapping 170.

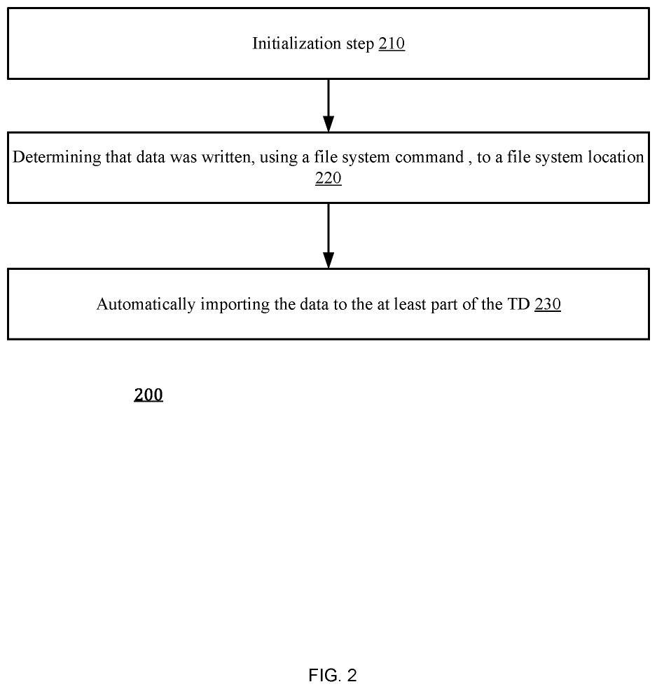

FIG. 2 illustrates method 200 for importing data to a tabular database (TD).

Method 200 may start by initialization step 210.

Initialization step may include associating at least part of the TD with a file system location. The file system location may be allocated (in any manner) to a user.

The associating may be triggered by a request from the user to perform the associating.

Alternatively—the storage system or other entity may determine the associating and inform the user about the associating—so that the user will be aware of where to write the data to be imported to the at least part of the TD.

The at least part of the TD may include the entire TD or a part of the TD. The part of the TD may include a table of the TD. The part of the TD may include one or more cells of the TD. The one or more cells may be a part of a column of the TD, a part of a row of the TD, one or more columns of the TD, one or more rows of the TD, a multidimensional part of the TD, and the like.

Multiple file system locations may be associated with multiple parts of the TD. For example, each table may be associated with a different file system location.

Initialization step 210 may be followed by step 220 of determining that data was written, using a file system command, to a file system location. The determining may include identifying existence of new files in the file system location.

The file system location is associated with at least a part of the TD. The association means that the storage system is programmed or otherwise configured to execute step 220 following the writing of the data to the file system location.

Step 220 may include constantly or periodically monitoring the file system location, or non-continuously monitoring the file system location, for example, monitoring the file system location upon an explicit command from a user. The frequency of monitoring may be determined based on various parameters such as a priority associated with user (higher frequency allocated to higher priority users), a priority associated with the data, the load (computational and/or memory and/or communication) related to the storage system, and the like.

Step 220 may be followed by step 230 of automatically importing the data to the at least part of the TD. Automatically means that once (or after a delay) the storage system finds the data in the file system location—it imports the data to the at least part of the TD. The user does not need to explicitly request a specific import of data, does not need to provide a name related to the part of the TD in which the data should be imported. Step 230 is executed regardless of one or names or one or more file system entities that stores the data, i.e., any file having any name may be imported, as long as it complies with other rules (e.g., conformance of the type of the file).

It should be noted that the user may write multiple data instances to the file system location before the multiple data instances are imported.

The importing of data may be followed by automatically deleting the data from the file system location. Alternatively—the data may be stored in the file system location for at least a predefined time or may be stored until receiving a filesystem command from a user for deleting files of already imported data or specific imported files.

Step 230 may include monitoring an import of data and preventing an import of data that were already imported. This will prevent the re-importing of already imported data.

A time of writing of the data to the storage system (included in metadata associated with the data, e.g., creation time of a file) may be used to distinguish current data and older data. It may also assist in determining the import of data—for example when different instances of data that were not imported are found in the storage system location—then their importing will follow the order of their time of writing.

Step 230 may be executed in response to one or more import rules that may impose limitations on an import of the data. For example—data included (at least in part) in a file of a format that is not supported for importing into the TD should not be imported.

The file system location may be a path name of a directory of the file system. The directory may be a root (upmost directory) of a sub-tree within the file system, that includes multiple hierarchies. The file system location may be a path name of a portion of the file system, the portion differs from a single file.

Method 200 may be executed in real time and the data may be of sizes that may exceed 1 Kbytes. In real time may mean at a data transfer rate that exceeds (for example) 1 Mbyte/second and/or within a fraction of a second, or a second or few seconds—or within any short period of time.

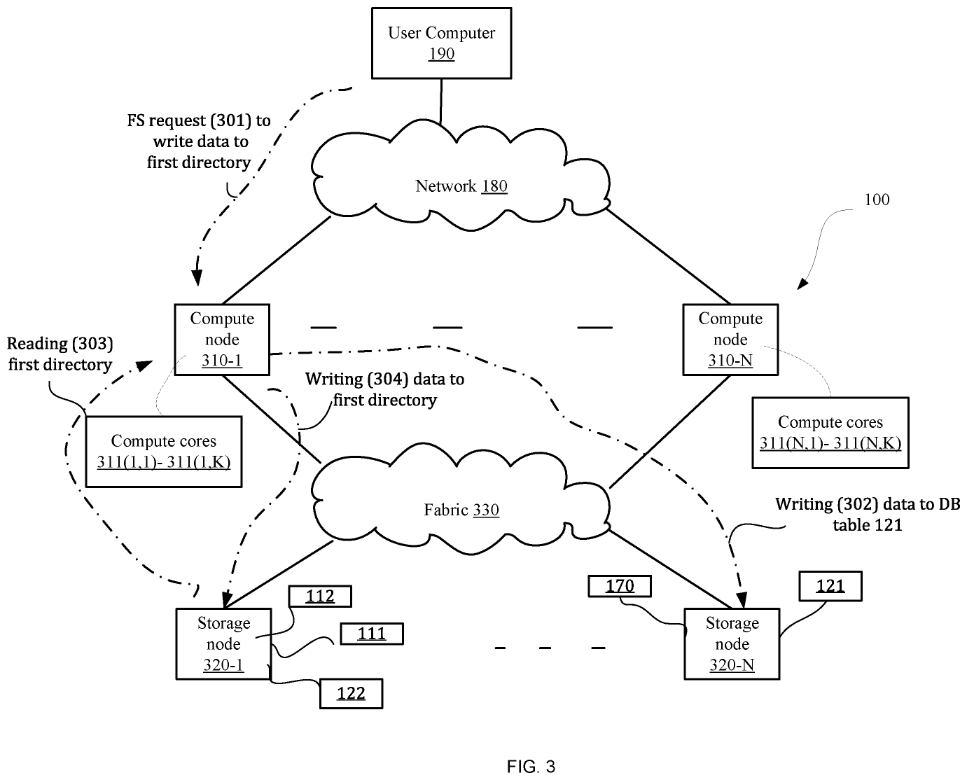

FIG. 3 shows an example diagram of a storage system 100, user computer 190 and an example of an implementation of method 200, according to the disclosed embodiments.

The storage system 100 includes a number of N compute nodes 310-1 through 310-N (hereinafter referred to individually as a compute node 310 and collectively as compute nodes 310, merely for simplicity purposes, N is an integer equal to or greater than 1). The compute nodes include (or may execute) multiple compute cores each (for example 311(1,1)-311(1,K) of compute node 310-1 and 311(N,1)-311(N,K) of compute node 310-N).

The storage system 300 also includes a number of M storage nodes 320-1 through 320-M (hereinafter referred to individually as a storage node 320 and collectively as storage nodes 320, merely for simplicity purposes, M is an integer equal to or greater than 1). The computer nodes 310 and the storage nodes 320 are connected through a communication fabric 330. M may equal N or may differ from N. The filesystem, the filesystem location, the data written to the filesystem location and the TD may be stored in the storage nodes.

In an embodiment, a compute node 310 may be realized as a physical machine or a virtual machine. A physical machine may include a computer, a sever, and the like. A virtual machine may include any virtualized computing instance (executed over a computing hardware), such as a virtual machine, a software container, and the like.

It should be noted that in both configurations (physical or virtual), the compute node 310 does not require any dedicated hardware.

A compute node 310 is configured to perform tasks related the execution of method 200. In an embodiment, each compute node 310 may interface one or more user devices (such as user device 190). A user device may host one or more user applications. The compute nodes may receive from the users (via the user devices) requests to associate one or more file system locations with one or more parts of one or more TDs, and/or request to write data to the one or more file system locations. The compute nodes interface the clients via one or more networks, such as network 180. The network may be, but is not limited to, the Internet, the world-wide-web (WWW), a local area network (LAN), a wide area network (WAN), and the like. The response to the query may be sent via the interface.

The steps illustrated in FIG. 3 also refer to the example of FIG. 1 and include:
a. Receiving (301) by the storage system and from user computer 190, a file system (FR) request to write data to a first directory 111. It is assumed that the FS request is received by compute node 301-1.
b. Writing (302) the data to a storage node such as storage node 302-1, by compute node 301-1.
c. Reading (303) the first directory by compute node 301-1.
d. Writing (304) the data to DB table 121 that is stored in storage node 320-N.

It should be noted that any of steps 301, 303 and 304 may be executed by any of the compute nodes of the storage system—and that steps 301, 303 and 304 may be executed by more than a single compute node. It should be noted that the directories (for example 111 and 112) and/or the DB tables (121 and 122) may be stored in any storage node.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Any reference to “consisting”, “having” and/or “including” should be applied mutatis mutandis to “consisting” and/or “consisting essentially of”.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method for importing data to a tabular database (TD), the method comprises:
determining that data was written, using a file system command, to a file system location; wherein the file system location is associated with at least part of the TD; and
automatically importing the data to the at least part of the TD.

2. The method according to claim 1 comprising associating the at least part of the TD with the file system location.

3. The method according to claim 2 wherein the file system location is allocated to a user, and wherein the associating is triggered by a request from the user to perform the associating.

4. The method according to claim 1 wherein the importing is executed without an explicit request, from a user, to import the data.

5. The method according to claim 1 comprising monitoring an import of data and preventing an import of data that were already imported.

6. The method according to claim 1 wherein the importing is based on a time of writing of the data.

7. The method according to claim 1 comprising preventing from importing the data when determining, based on one or more import rules, not to import the data.

8. The method according to claim 7 wherein the determining not to import the data is based on a format of a file that comprises at least some of the data.

9. The method according to claim 1 wherein the at least part of the TD belongs to a column of the TD.

10. The method according to claim 1 wherein the TD comprises multiple columns that are associated with multiple file system locations.

11. The method according to claim 1 wherein the file system location is identified by a path name of a directory of the file system.

12. The method according to claim 1 wherein the determining that data was written comprises repetitively checking content of the file system location.

13. The method according to claim 1 wherein the importing is executed regardless of one or more names of one or more file system entities that stores the data.

14. A non-transitory computer readable medium for importing data to a tabular database (TD), the non-transitory computer readable medium comprises:
determining that data was written, using a file system command, to a file system location; wherein the file system location is associated with at least a part of the TD; and
automatically importing the data to the at least part of the TD.

15. The non-transitory computer readable medium according to claim 14 that stores instructions for associating the at least part of the TD with the file system location.

16. The non-transitory computer readable medium according to claim 15 wherein the file system location is allocated to a user, and wherein the associating is triggered by a request from the user to perform the associating.

17. The non-transitory computer readable medium according to claim 14 wherein the importing is executed without an explicit request, from a user, to import the data.

18. The non-transitory computer readable medium according to claim 14 that stores instructions for monitoring an import of data and preventing an import of data that were already imported.

19. The non-transitory computer readable medium according to claim 14 wherein the importing is based on a time of writing of the data.

20. The non-transitory computer readable medium according to claim 14 that stores instructions for preventing from importing the data when determining, based on one or more import rules, not to import the data.

21. The non-transitory computer readable medium according to claim 20 wherein the determining not to import the data is based on a format of a file that comprises at least some of the data.

22. The non-transitory computer readable medium according to claim 14 wherein the at least part of the TD belongs to a column of the TD.

23. The non-transitory computer readable medium according to claim 14 wherein the TD comprises multiple columns that are associated with multiple file system locations.

24. The non-transitory computer readable medium according to claim 14 wherein the file system location is identified by a path name of a directory of the file system.

25. The non-transitory computer readable medium according to claim 14 wherein the determining that data was written comprises repetitively checking content of the file system location.

26. The non-transitory computer readable medium according to claim 14 wherein the importing is executed regardless of one or more names of one or more file system entities that stores the data.

27. A computer core that is configured to:
determine that data was written, using a file system command, to a file system location; wherein the file system location is associated with at least part of a tabular database (TD); and
automatically import the data to the at least part of the TD.
